(19) United States
(12) Patent Application Publication
(10) Pub. No.: US 2024/0060921 A1
(43) Pub. Date: Feb. 22, 2024

(54) Flexible PH Sensor and Improved Methods of Manufacture

(71) Applicants: Kenneth Edward Salsman, Pleasanton, CA (US); Jungchih Chiao, Grand Prairie, TX (US); Robert L. O'Donnell, San Jose, CA (US)

(72) Inventors: Kenneth Edward Salsman, Pleasanton, CA (US); Jungchih Chiao, Grand Prairie, TX (US); Robert L. O'Donnell, San Jose, CA (US)

(21) Appl. No.: 18/235,328

(22) Filed: Aug. 17, 2023

Related U.S. Application Data
(60) Provisional application No. 63/399,046, filed on Aug. 18, 2022.
(60) Provisional application No. 63/489,580, filed on Mar. 10, 2023.

(51) Int. Cl. G01N 27/07

(52) U.S. Cl. CPC G01N 27/07

(57) ABSTRACT

A flexible pH sensor having a unique stacking of layers is described. The sensor may be used in various applications. Methods of manufacturing the flexible pH sensor are also described, including the manner in which iridium oxides are provided.

### CROSS-REFERENCE TO RELATED APPLICATION

This application claims the benefit of, and priority to, U.S. Provisional Application Nos. 63/399,046, attorney docket no. SENS-00301, filed Aug. 18, 2022, and 63/489,580, attorney docket no. SENS-00600, filed Mar. 10, 2023, the contents of which are incorporated herein by reference.

### FIELD OF THE INVENTION

The current invention generally relates to flexible electronics and pH measurement, including flexible pH sensors, and methods of manufacturing same.

### BACKGROUND OF THE INVENTION

Many current pH sensors utilize a reference electrode to maintain a steady reference voltage, and a working or measurement electrode held within a pH sensitive glass bulb. The reference electrode, and the working electrode along with the glass bulb, are immersed in a fluid whose pH value is to be determined. The voltage potential across the glass bulb is dependent upon the H⁺ ion concentration of the test fluid. In this way, voltage readings may be taken across the electrodes to determine the pH level of the fluid.

However, there are significant drawbacks with these types of pH sensors and their method of operation. For example, the fragility of the glass, the limitations on long term measurements, and the requirement of repeated calibrations after only a few measurements, render these types of pH sensors unsuitable for many consumer, medical and other applications. As such, these pH sensors are not suitable for applications that may require the pH sensor to be in contact with a patient's skin, to be held within a bandage, to be placed within food, etc. The fragility and/or the size or configuration of these pH sensors also render them unsuitable for applications where the sensor must fit in a small location, where the configuration of the sensor may need to be flexible because it reside at or in a location whose configuration varies, where the sensor must have sufficient strength, etc.

Other types of pH sensors using flexible substrates also are becoming available. However, the architectures of these pH sensors are generally limited and are not easily manufactured in bulk. As such, these types of flexible sensors are not cost efficient for many consumer and industrial applications.

Accordingly, there is a need for a pH sensor that addresses the foregoing and other drawbacks. To this end, there is a need for flexible pH sensors that may be used for various applications. There also is a need for pH sensors with a robust architecture to withstand locations and applications requiring strength. There is also a need for pH sensors that may be manufactured efficiently and at low cost, including manufacturing methods that use currently available manufacturing apparatus.

### SUMMARY OF THE INVENTION

An aspect of the invention involves a pH sensor having a flexible and physically stable structure.

Another aspect of the invention regards the use of two to three electrodes.

Another aspect of the invention regards, coatings that are non-reactive with the solution whose pH is being measured.

Another aspect of the invention regards the use of an IrOx coating on an active or working electrode that may act as a proton transfer film allowing H+ ions to pass through the coating while preventing other ions that may be in solution.

Other aspects of the invention are discussed herein.

### BRIEF DESCRIPTION OF THE DRAWINGS

FIGS. 1A-1B show top and side views of a pH sensor, respectively.

FIGS. 2A-2B show exploded and assembled side views of a pH sensor, respectively.

FIG. 3 shows top and side views of a pH sensor.

FIG. 4 shows top views of a reference electrode and an active electrode, along with portions of a pH sensor.

FIG. 5 shows a top view of a pH sensor.

FIG. 6 shows a top view of a pH sensor.

FIGS. 7A-7D show top and side views of a pH sensor.

FIG. 8 shows a side view of a pH sensor.

FIGS. 9A-9D show top and side views of a pH sensor.

FIGS. 10A-10B show top and perspective views of a pH sensor and packaging therefor.

FIG. 11 shows a substrate used to form a pH sensor.

FIGS. 12A-13B show methods of manufacture of a flexible pH sensor according to exemplary embodiments hereof.

FIGS. 14-15 show aspects of manufacturing equipment that may be used to form a flexible pH sensor according to exemplary embodiments hereof.

### DETAILED DESCRIPTION OF THE PREFERRED EMBODIMENTS

In general, and according to exemplary embodiments hereof, pH sensors are described which preferably reflect a flexible and physically stable architecture, as well as other beneficial attributes. In some embodiments, the pH sensor may include a flexible polyimide sheet (or similar) with at least one surface coated with gold (or a similar transitional material). Electrodes (e.g., reference and/or a working electrodes) may be formed onto the gold layer using appropriate metallization and/or metallization materials. For example, a reference electrode may be formed on the gold layer using silver/silver chloride (Ag/AgCl or Ag:AgCl) and/or a working electrode may be formed using iridium oxide (IrO₂). The IrOx (or similar) coating on the working electrode may act as a proton transfer film by allowing H⁺ ions to pass through the IrOx coating, while preventing other ions within the test solution from interacting with the measurement circuit. This may provide a true pH measurement rather than a measurement of the total ionic potential across the test solution. In other words, the current invention preferably provides a more accurate determination of pH level of the test solution. This represents a significant differentiation from existing pH sensors which may simply measure the potential voltage across the sample solution. Other suitable metallization and/or metallization materials may also be used.

In some embodiments, the pH sensor is packaged such that at least a portion of the electrodes are exposed at a fixed spacing to make contact with the fluid or substance to be pH tested. The packaging also may include electrical connectivity to external measurement equipment that may be used to measure electrical parameters (e.g., voltage potential) across the electrodes to determine pH level readings. The package also may seal the electrical connections within the pH sensor and protect the sensor from the environment.

The result is a lower cost, flexible pH sensor that may be incorporated into a wide variety of consumer, medical, and other applications. For example, the flexible sensor may provide disposable point-of-care devices that may be incorporated into bandages to sense wound conditions, form-fitting and wearable sensors that may be incorporated into clothing to make skin contact, and sensors integrated into diapers to detect soiling and/or potential urinary tract infections. Other applications include biological media, the food industry, the nuclear field, and the oil and gas industry to name a few.

In addition to the disclosure provided herein, the disclosure in the article, Printable and Flexible Iridium Oxide-Base pH Sensor by a Roll-to-Roll Process, Chemosensors 2023, 11, 267. https://doi.org/10.3390/chemosensors11050267, is incorporated by reference as if fully set forth herein.

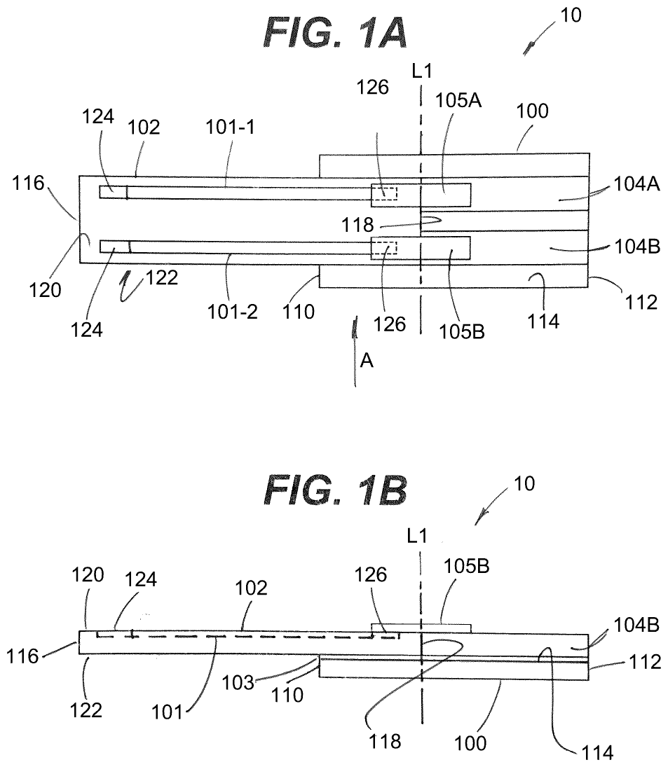

FIG. 1A shows a top view of a flexible pH embodiments. However, the embodiment of FIGS. 1A, 1B still reflects aspects of the current inventions.

In some embodiments, as shown in FIGS. 1A and 1B, the pH sensor 10 includes a reference electrode 104A and an active or working electrode 104B, each comprising a flexible polyimide sheet (or similar) coated on at least one side with a metallic coating (i.e., metallized). For example, in some embodiments, the reference electrode 104A may include a metallic coating comprising silver/silver chloride (Ag/AgCl), and the working electrode 104B may include a metallic coating comprising iridium oxide (IrO₂). During use, a sample fluid whose pH level is being determined, is provided across the reference and working electrodes 104A, 104B to complete the circuit and voltage potential measurements are made between the electrodes 104A, 104B (e.g., using external electrical measurement equipment) to determine the fluid's or solution's pH level. Other suitable metallic coatings also may be used with any of the embodiments described herein. And while various substrates are described herein primarily as polyimide substrates, any suitable substrates may be used.

In some embodiments, a polyimide base sheet 100 is provided to support the electrodes 104A, 104B. The base sheet 100 may include a first end 110, a second end 112 opposite the first end 110, and an upper surface 114 extending between the first and second ends 110, 112.

The reference and working electrodes 104A, 104B may be mounted on the base sheet's upper surface 114 with their metallized surfaces facing upwards and extending from the sheet's second end 112 to an interior location L1 between the second end 112 and the first end 110. The electrodes 104A, 104B may be mounted to upper surface 114 with a pressure sensitive adhesive (PSA) 103 as described below, and may be aligned side-by-side and separated by a gap to prevent electrical shorting between the two. It is preferred that the electrodes 104A, 104B not extend past the base sheet's second end 112 and the PSA 103 to avoid excessive flexing of the electrode(s) that could potentially damage the electrode coatings.

In addition, a second polyimide sheet 102 may be mounted onto the base sheet's upper surface 114 between the interior location L1 and the base sheet's first end 110. As described below, the second sheet 102 may provide electrical connectivity to the reference and working electrodes 104A, 104B. The second polyimide sheet 102 may include a first end 116, a second end 118 opposite the first end 116, and upper and lower surfaces 120, 122 extending between the first and second ends 116, 118. As shown, it may be preferable that the second sheet's second end 118 generally abut against both the reference electrode 104A and the working electrode 104B each at the interior location L1. In addition, it may be preferable that the second sheet's first end 116 extend beyond the base sheet's first end 110 such that it may be electrically connected to other equipment (e.g., electrical measurement equipment for taking the sensor readings).

In some embodiments, the reference and working electrodes 104A, 104B and/or the second polyimide sheet 102 may be bonded to the upper surface 114 of the base polyimide sheet 100 using a pressure sensitive adhesive (PSA) film 103 that preferably includes adhesive on both sides. For example, a non-limiting PSA film may include the #1567 film and/or the #1510 film, each produced by 3M®. Other types of suitable adhesives also may be used.

As shown in FIG. 1A, it may be preferable that the width of the polyimide base sheet 100 be wider than the width of the second polyimide sheet 102 such that the base sheet 100 extends outward (upward and downward from the perspective of FIG. 1A) on either side of the reference and working electrodes 104A, 104B. This may provide room for the mounting and bonding of the electrodes 104A, 104B as described herein. However, it is appreciated that this may not be necessary for all applications.

In some embodiments, the second polyimide sheet 102 includes one or more conductive metal pathways 101 that may be printed, etched or otherwise provided on sheet 102, and that extend from a first position at or near the second sheet's first end 116 to a second position at or near the second sheet's second end 118. In some embodiments, each conductive pathway 101 includes a first exposed contact pad 124 at the first position and a second exposed contact pad 126 at the second position.

In some embodiments, as shown in FIG. 1A, a first conductive pathway 101-1 is arranged to provide electrical connectivity to the reference electrode 104A, and a second conductive pathway 101-2 is arranged to provide electrical connectivity to the working electrode 104B. In this arrangement, it is preferable that the second contact pad 126 of each conductive pathway 101 is adjacent to the interior end of its corresponding electrode 104A, 104B. In this way, the electrodes 104A, 104B and their corresponding contact pads 126 may be electrically connected as described below.

In some embodiments, each conductive pathway 101 includes an insulating coating in the areas between the first and second contact pads 124, 126 so that the conductive pathways 101 are properly insulated while leaving the pads 124, 126 exposed. An insulative plastic and/or lamination also may be used for this purpose. In any event, it is preferable that the second polyimide sheet 102 remain flexible.

In some embodiments, as shown in FIGS. 1A and 1B, the second contact pad 126 of the first conductive pathway 101-1 may be electrically connected to an interior end of the reference electrode 104A, and the second contact pad 126 of the second conductive pathway 101-2 may be electrically connected to an interior end of the working electrode 104B. In some embodiments, these connections may be provided using strips of conductive material such as, but not limited to, copper tape. For example, a first strip 105A of conductive tape may be applied between the first pathway's contact pad 126 and the reference electrode 104A, and a second strip 105B of conductive tape may be applied between the second pathway's contact pad 126 and the working electrode 104B. It is preferable that the first and second strips 105A, 105B do not touch one another (e.g., to avoid short circuits) and that an adequate surface area of the contact pads 126 and the corresponding electrodes 104A, 104B are covered by the conductive tape to provide adequate electrical connectivity.

In addition, it may be preferable that the first contact pads 124 of the conductive pathways 101 be designed to connect to an external connector such as a Zero Insertion Force (ZIF) connector or other connector with a suitable attachment format (e.g., to electrically connect the pH sensor 10 to the electrical measurement equipment).

The arrangement of the components described above, and the manner in which they are attached, allow the sensor 10 to be sufficiently flexible for use in various applications as described below. As also described below, this configuration of components also provides for an efficient method of manufacture of sensor 10. These benefits also apply to the embodiments described later on.

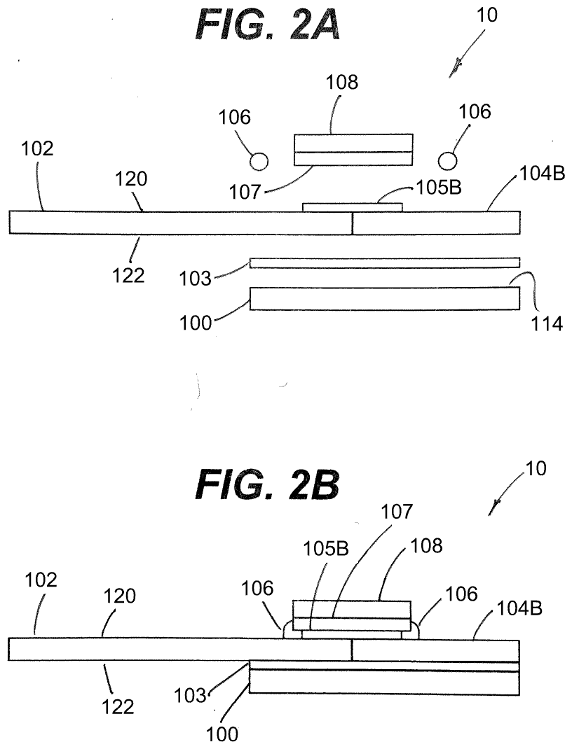

FIGS. 2A and 2B show additional elements that may be added to the pH sensor 10 of FIGS. 1A and 1B, with FIG. 2A showing an exploded view, and FIG. 2B showing the components of FIG. 2A as assembled. For example, reinforcement and/or protective elements may be added to the pH sensor 10 as now described.

In some embodiments, a small amount of adhesive 106 (e.g., epoxy or similar) may be applied to the region including the first and second strips 105A, 105B of conductive tape to effectively seal the electrical connections between the strips 105A, 105B and the respective electrodes 104A, 104B beneath, as well as the second electrical contact pads 126 beneath. In this way, the electrical connections may be protected from the external environment (e.g., from contaminants that may cause erroneous pH readings). The adhesive 106 is generally shown as a bead in FIG. 2A that may be applied to assume the potting configuration shown in FIG. 2B. However, adhesive 106 may be configured and may be applied to sensor 10 in other ways.

An additional protective sheet 108 of polyimide material (or similar) may be bonded to the adhesive-coated first and second conductive tape strips 105A, 105B using an intermediate layer 107 of PSA or similar. The protective sheet 108 may further protect the electrical connections by acting as a cover to protect the connections from external mechanical forces (such as abrasion).

It is preferred that even with the additional protective and/or reinforcement components described in connection with FIGS. 2A, 2B, sensor 10 still exhibits sufficient flexibility for various applications. It is also preferred that these protective and/or reinforcement components may be added to sensor 10 while still maintaining an efficient method of manufacture.

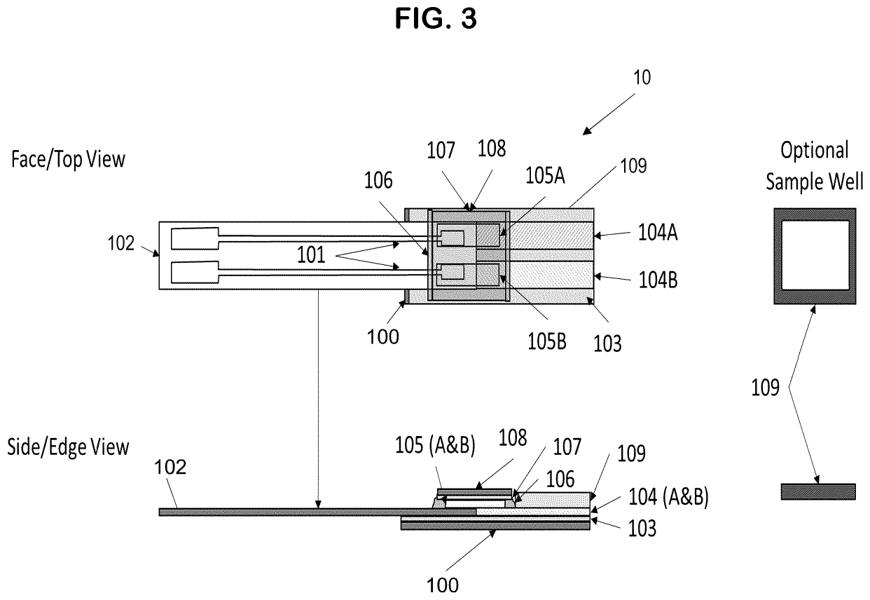

Another embodiment or feature of the current invention is shown in FIG. 3 (including a top view and a side view of the sensor 10). As shown, a reservoir or well may be formed on an upper surface of the reference and working electrodes 104A, 104B to hold the sample fluid(s) being tested. In some embodiments, a reservoir frame 109 including a central aperture may be placed onto the top surfaces of the electrodes 104A, 104B and sealed fluid-tight thereto using PSA or similar. The frame 109 provides reservoir sidewalls and the central aperture allows test fluid held therein to physically contact the electrodes 104A, 104B.

In some embodiments, the frame 109 comprises a flexible material such as vinyl, polyimide, or other suitable materials, and includes a height selected to meet the requirements of each specific application. As such, the flexibility of the overall sensor 10 may be maintained. Though FIG. 3 shows the well or reservoir frame 109 shaped as a square, other shapes may be used. As an alternative, PSA or other suitable material may be applied in the appropriate locations and in a manner to itself form the walls of well 109.

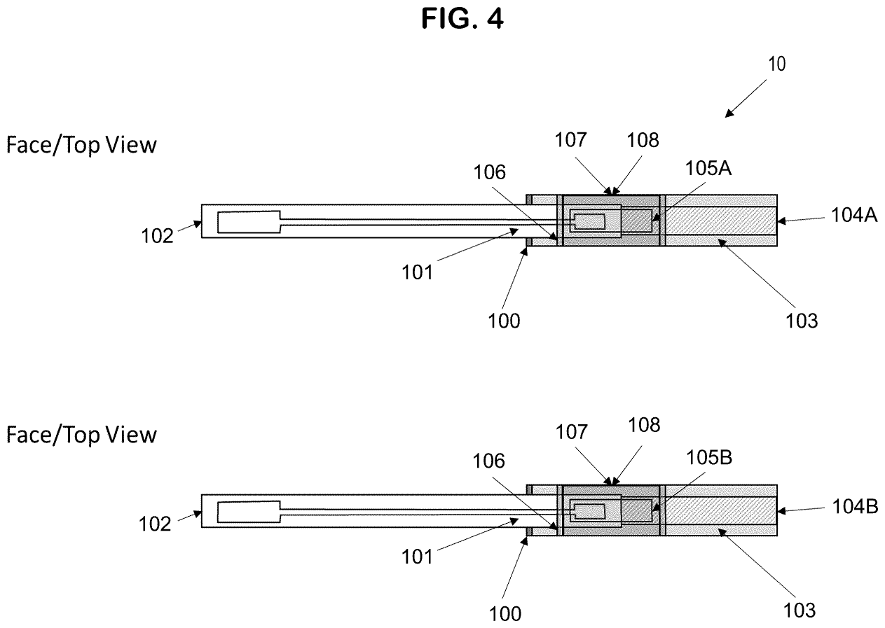

In some embodiments, as shown in FIG. 4, the pH sensor 10 of FIGS. 1A, 1B, 2A, and 2B may be divided into two separate substrates, with a first substrate including the reference electrode 104A and its associated elements and a second substrate including the working electrode 104B and its associated elements. This results in two self-contained and fully functioning connectorized electrodes 104A, 104B that may be used together to make pH readings, e.g., connected to the millivolt sensing pH calculating electronics. Having the electrodes 104A, 104B on separate substrates allows the two electrodes 104A, 104B to be positioned at different separation distances, at different orientations with respect to one another, (e.g., reactive measurement surfaces being face-to-face, in opposite directions, at offset angles with respect to one another, etc.), and/or otherwise configured as required for different applications.

The applicable descriptions, aspects and/or elements of the embodiments of FIGS. 1A, 1B, 2A, and 2B described above, or with other embodiments described below, may apply to the embodiments of FIG. 4. As such, FIG. 4 shows an alternative that may apply to various embodiments of the current invention.

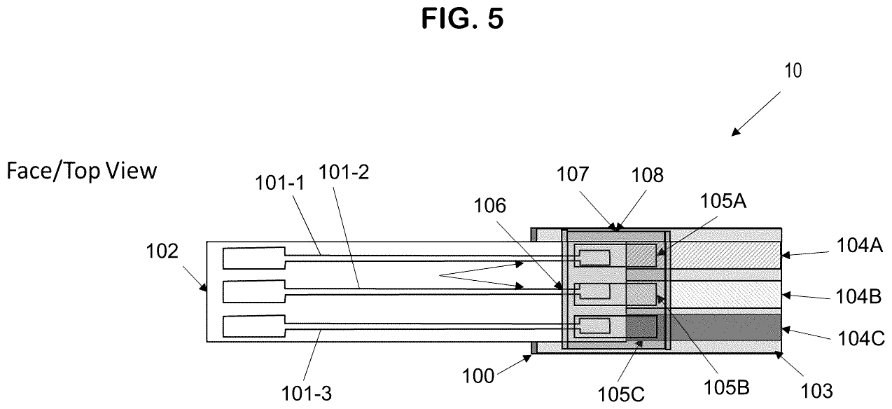

Another embodiment of the current invention is shown in FIG. 5, where the previously described pH sensor 10 may be expanded to include a third electrode 104C and its associated elements (e.g., connected to a corresponding third conductive pathway 101-3). The third electrode 104C may be aligned beside the first and second electrodes 104A, 104B (or in any other desired location and/or orientation) and may be configured to act as an electrical ground for the pH sensor 10 and its accompanying electrical measurement equipment. The third electrode 104C may be metalized using a metal coating of suitable material(s), e.g., Ag:AgCl. In this way, the third electrode 104C may reduce electrical noise and/or interference associated with pH measurements that may adversely affect the accuracy of such measurements. Any of the applicable descriptions, aspects and/or elements of the embodiments of FIGS. 1A, 1B, 2A, and 2B described above, or with other embodiments described below, also may apply to the embodiments of FIG. 5. As such, FIG. 5 shows an alternative that may apply to various embodiments of the current invention.

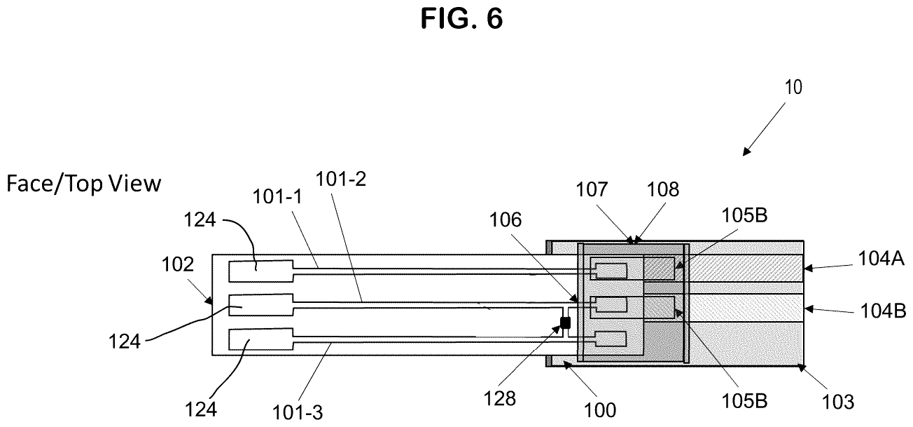

Another embodiment of the current invention is shown in FIG. 6, where a thermal sensor 128 (e.g., a thermistor or other thermal sensing device) may be incorporated into the pH sensor 10. The thermal sensor 128 may be configured to sense the temperature of the solution under test and to provide or communicate the sensed temperature information to the associated measurement equipment (or to a controller, etc.). In this way, the effects of temperature variances during the measurement process may be accounted for.

For example, in some embodiments, the measurement equipment may apply temperature correction factors to account for slight or other temperature variations sensed during the measurement procedure. The temperature correction factors may be determined by calibrating the pH sensor 10 and the measurement equipment over various temperature ranges, through theoretical calculations, and/or by other techniques. In this way, the pH sensor 10 may be pre-calibrated and may not require on-site and/or in-the-field calibration. Other types of calibrations (e.g., other than temperature) may be performed prior to use of the pH sensor 10, so that other types of correction factors may also be applied.

In some embodiments, as shown in FIG. 6, the pH sensor 10 of FIGS. 1A, 1B, 2A, and 2B, or in other embodiments, may include a third conductive pathway 101-3 aligned next to the existing pathways 101-1, 101-2. This also may resemble the embodiment of FIG. 5 but without the third electrode 104C and its associated bonding elements configured with the additional pathway 101-3.

In some embodiments, as shown in FIG. 6, the thermal sensor 128 includes a two-lead device (e.g., a temperature sensitive resistor), with a first lead electrically connected to the third conductive pathway 101-3, and a second lead electrically connected to the adjacent conductive pathway 101-2 configured with the working electrode 104B. The thermistor or similar temperature sensing device should be between the working electrode (IrOx) and the ground electrode (one of the Ag:AgCl electrodes). This allows a voltage to be sent from the electronics to detect the temperature calibrated resistance of the thermistor in one mode of operation and to read the difference in electrical potential of the working and ground electrodes in the pH reading mode. Another option is the use of an additional conductor line to isolate the thermistor and provide separate electrical reading of the temperature.

Given this arrangement, electrical measurement equipment may be configured (e.g., using the first contact pads 124) to measure a varying resistance of the thermal sensor 128 across the conductive pathways 101-2, 101-3. This varying resistance may represent a varying temperature of the working electrode 104B, and thereby a varying temperature of the pH sensor 10 itself. This temperature information may then be used to apply correction factors to the pH readings to improve the accuracy of the measurements. It is appreciated that the sensor 128 may be surface mounted or otherwise mounted in place using other mounting techniques.

In some embodiments, a switching network may be employed between the pH sensor 10 of FIG. 6 and the measurement equipment to toggle between taking pH readings and temperature readings. For example, a switch may be controlled to first direct electrical measurements across the conductive pathways 101-2, 101-3 to measure electrical parameters (e.g., the resistance) of the thermal sensor 128 and to use this information to determine any temperature variations. The switch may then be controlled to redirect electrical measurements across the conductive pathways 101-1, 101-2 to measure electrical parameters (e.g., voltage potentials) between the reference and working electrodes 104A, 104B to gather pH readings information. In some embodiments, it may be preferable that the additional conductive pathway 101-3 be terminated into a properly matched impedance while the pH measurements are being made between the electrodes 104A, 104B to avoid a voltage signal leak across the thermal sensor 128 that may affect the pH readings.

While FIG. 6 depicts the thermal sensor 128 as being connected between two conductive pathways 101-1, 101-3 at a slight offset distance from the working electrode 104B, it also is contemplated that the thermal sensor 128 may be connected at and/or directly adjacent to the electrode 104B.

In other embodiments, a fourth conductive pathway may be added generally aligned with and adjacent the third conductive pathway 101-3, and the temperature sensor 128 may be electrically connected between the third and fourth pathways instead of between the third and second pathways 101-3, 101-2. In this way, the conductive pathway 101-2 and its corresponding working electrode 104B are no longer in the measurement path of the temperature sensor 128. As such, the working electrode 104B may be electrically isolated from the temperature sensor 128 and the measurement equipment connected thereto.

Given the above configurations including the thermal sensor 128, it also is contemplated that other devices may be similarly configured with one or more conductive pathways 101 on the pH sensor 10.

For example, in some embodiments, other types of sensor devices such as, but not limited to, pressure, orientation/movement (e.g., accelerometers, gyroscopes, etc.), shock/vibration, and/or other types of sensors also may be configured with one or more conductive pathways 101. In some embodiments, the sensors may be configured with pathways 101 associated with the electrodes 104A, 104B while in other embodiments, the sensors may be configured with additional pathways 101 isolated from the electrodes 104A, 104B.

In other embodiments, one or more data chips may be configured with one or more conductive pathways 101 that may provide identification information, calibration data (e.g., pre-calibration correction factors as described in other sections), and other types of information relating to the pH sensor 10. This information may include unique identification credentials, information regarding the type and test range(s) of the pH sensor 10, and/or other pertinent information.

In other embodiments, additional circuitry and/or electrical components may be integrated with the pH sensor 10, e.g., on the polyimide sheet 102. For example, data communication circuitry including a signal amplifier may be provided thereby enabling the pH sensor 10 to operate as a wireless sensor that may communicate with other devices to provide pH data in an Internet of Things (IOT) environment.

In any of these embodiments, it is appreciated that the measurement equipment (and/or a controller) may implement one or more correction factors and/or other types of calculations using information provided by the sensors to improve the accuracy of the pH measurements and/or to facilitate use of the pH sensor 10 as an integrated sensor suite.

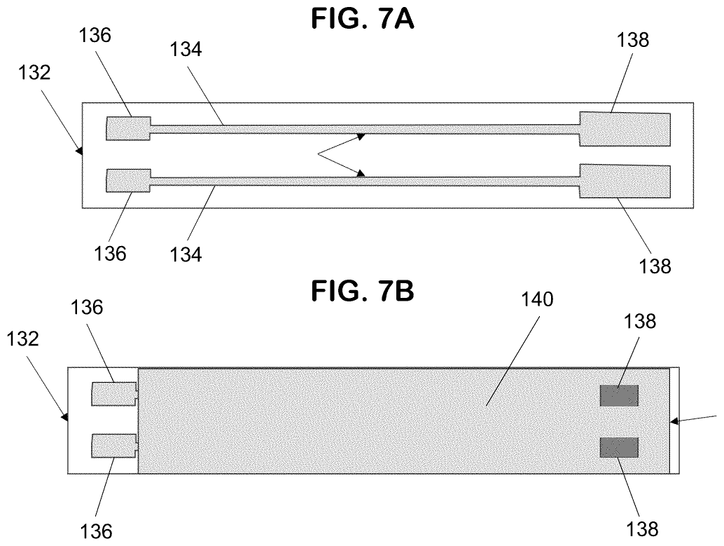

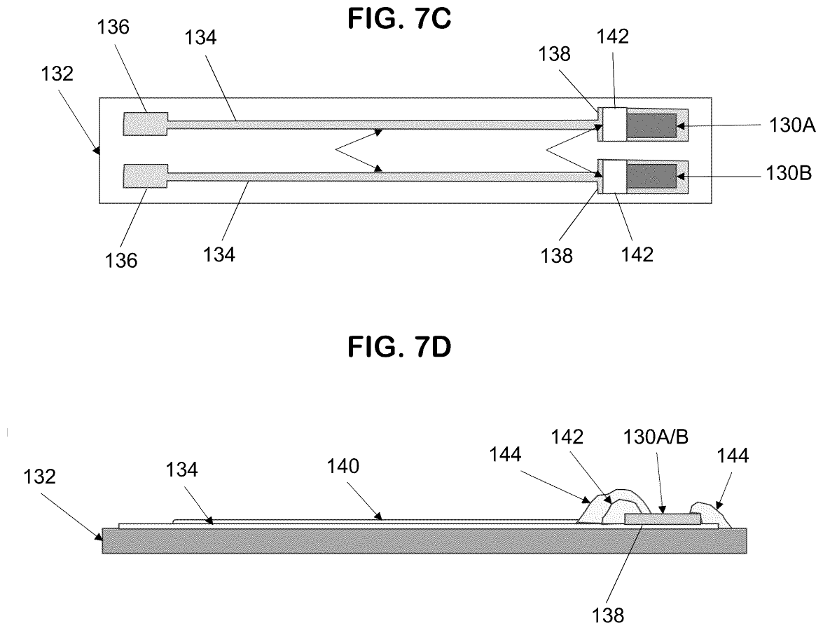

FIGS. 7A-7D show additional embodiments of the pH sensor 10 that include rigid reference and working electrodes 130A, 130B mounted directly to a base substrate 132. FIGS. 7A-7C show top views and FIG. 7D shows a side view thereof.

In some embodiments, the reference and working electrodes 130A, 130B may be fabricated using a hard non-flexible substrate such as a ceramic or semiconductor material (or similar). The reference electrode 130A may be coated with AgCl and the working electrode 130B may be coated with IrOx, and both electrodes 130A, 130B may be baked to form physically and chemically stable electrode components.

In some embodiments, as shown in FIG. 7A, the base substrate 132 may comprise a rigid material (e.g., a printed circuit board (PCB), a ceramic board, etc.), a semi-rigid material, and/or a flexible material (e.g., polyimide film, plastic, etc.). As with other embodiments described herein, conductive pathways 134 are formed on an upper surface of the substrate 132 with each pathway 134 including a first contact pad 136 at or near one end of the substrate 132 and a second contact pad 138 at or near the other end of the substrate 132. As shown in FIGS. 7B and 7D, portions of the conductive pathways 134 between the contact pads 134, 136 may be coated with an insulating layer 140 while leaving the contact pads 136, 138 exposed.

In some embodiments, as shown in FIGS. 7C and 7D, the reference electrode 130A may be mounted directly on top of a first contact pad 138 with its AgCl coated surface facing upward, and the working electrode 130B may be mounted directly on top of an adjacent contact pad 138 with its IrO₂ coated surface also facing upward. In other embodiments, the reference and working electrodes 130A, 130B may be mounted facing upward on the base substrate 132 directly adjacent to a corresponding contact pad 138 (e.g., in close enough proximity to be electrically connected thereto as described below). The electrodes 130A, 130B may be bonded and held in place using adhesive or other suitable techniques.

In some embodiments, as shown in FIGS. 7C and 7D, the reference and working electrodes 130A, 130B may be electrically connected to their respective underlying contact pads 138 using a conductive epoxy 142 or similar, or by using a wire bond (e.g., as used in packaging semiconductor chips). In addition, a protective layer of epoxy or polymer material 144 may be applied to cover the conductive epoxy 142 (or the wire bond) and the surrounding areas of the contact pads 138 including the edges of the reference and working electrodes 130A, 130B (including any edges that may not be metallized). In this way, these areas may be sealed and protected from the environment. The flexible reference and/or working electrodes 104A, 104B (e.g., utilizing metallized flexible polyimide substrates as described in other sections) also may be used in the above embodiments.

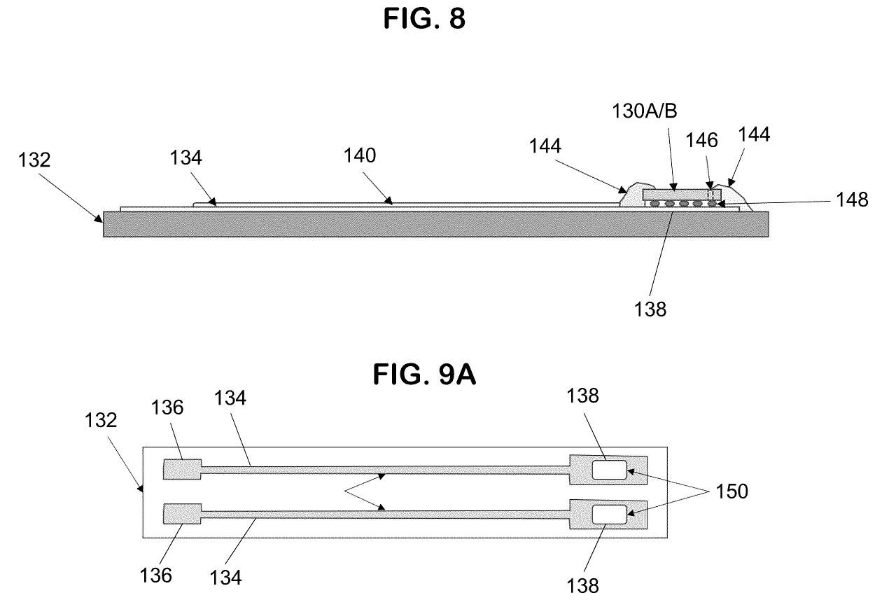

Another embodiment of the current invention, depicted in FIG. 8, shows the base substrate 132 with conductive pathways 134, and an insulating layer 140 between the contact pads 136, 138. The reference and working electrodes 130A, 130B may be mounted directly onto their respective contact pads 138 (e.g., using adhesive, etc.) and may each include one or more electrical vias 146 passing from the upper metallized surfaces on the electrodes 130A, 130B to the contact pads 138 below. In some embodiments, the vias 146 may be electrically connected to solder balls 148 in electrical communication with the contact pads 138 for electrical connectivity. In addition, a protective layer of epoxy or polymer material 144 may be applied to cover the surrounding areas of the contact pads 138 including the edges of the reference and working electrodes 130A, 130B (including any edges that may not be metallized) to seal and protect these areas from the environment.

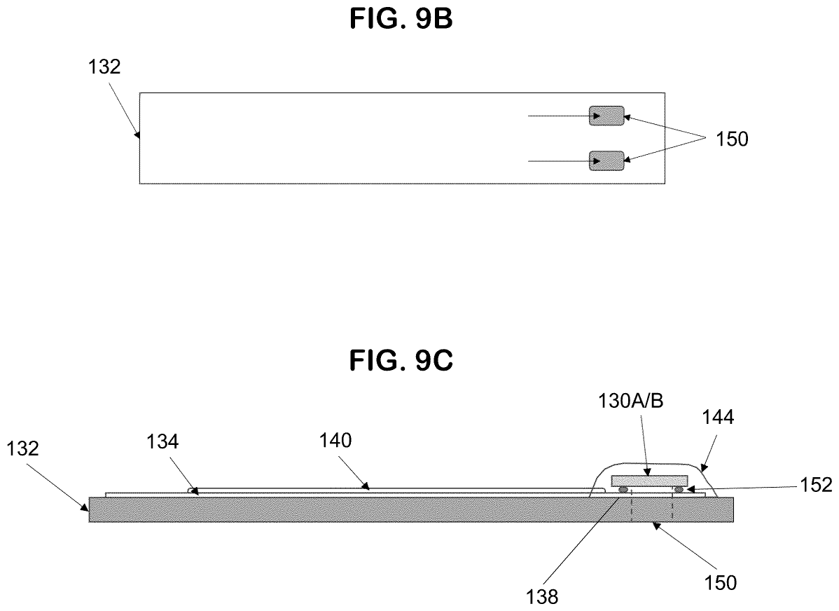

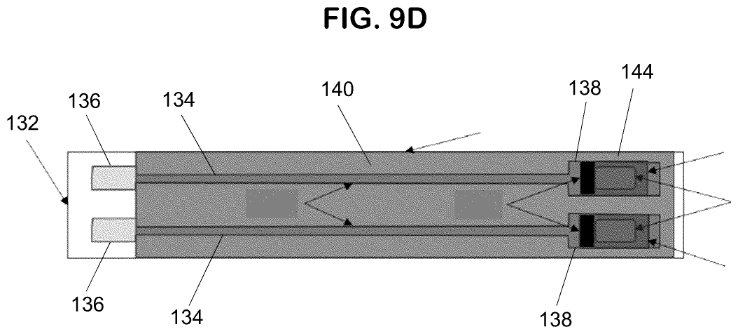

In another embodiment of the current invention, as shown in FIG. 9A-9D, the base substrate 132 with conductive pathways 134 between the contact pads 136, 138 may be provided with apertures 150 passing through the contact pads 138 and through the base substrate 132 beneath. All of the apertures 150 are preferably identical, though varying configurations may be used. FIG. 9A shows the base substrate 132 and apertures 150 from above and FIG. 9B shows the same from below.

In this embodiment, the reference and working electrodes 130A, 130B may be mounted on each respective contact pad 138 with their metallized surfaces facing downward towards each respective aperture 150 as shown in FIG. 9C. In some embodiments, the downward facing metallized surfaces of the electrodes 130A, 130B may be electrically connected to portions of the contact pads 138 surrounding the apertures 150 using solder or gold ball connections 152. Other types of connections also may be used such as, without limitation, Z-axis conductive adhesive, printed conductive adhesive, and/or other techniques.

In addition, because the electrodes 130A, 130B are facing downwards, the upper surface of the base substrate 132, including the contact pads 138 and electrodes 130A, 130B attached thereto, may be covered with insulation layers 140, 144 (e.g., epoxy, polymer or similar) while leaving the input contact pads 136 exposed to enable connectivity to measurement equipment. This is shown in FIG. 9D.

In use, the electrode end of the pH sensor 10 may be immersed into a test fluid such that the fluid may pass through the apertures 150 and interact with the metallized surfaces of the electrodes 130A, 130B.

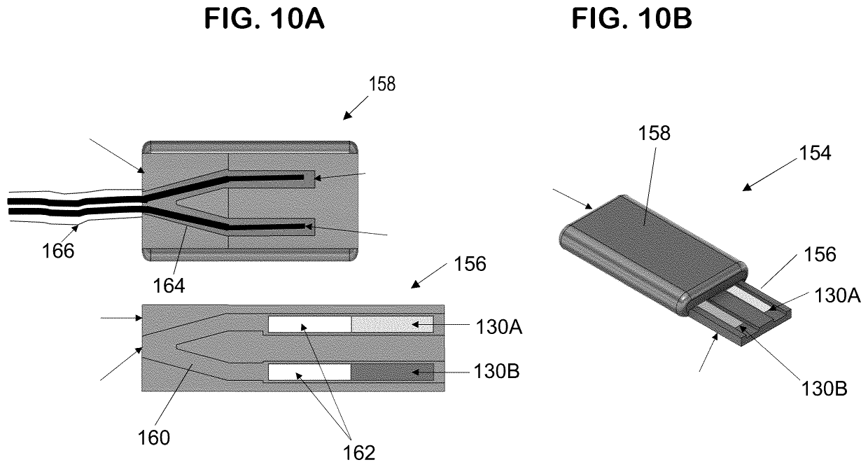

In another embodiment of the current invention, as shown in FIGS. 10A and 10B, the reference and working electrodes 130A, 130B may be packaged into a housing 154. In some embodiments, the housing 154 may include a tray 156 designed to support and secure the electrodes 130A, 130B, and a cover 158 designed to support and secure electrical connectivity to the electrodes 130A, 130B.

In some embodiments, the tray 156 may include a track 160 (e.g., a slight recess or similar) including a first portion designed to secure the reference electrode 130A and a second portion designed to secure the working electrode 130B. The two portions may converge into a single track at the input to the tray 156 for connectivity. The reference and working electrodes 130A, 130B may be secured within the track 160 using adhesive and may be aligned side-by-side and separated by a gap for electrical isolation. As shown in FIG. 10A, the electrodes 130A, 130B may each include an interior connection portion 162 that is not metallized for electrical connectivity.

In some embodiments, the cover 158 may include a channel 164 (e.g., a recess or similar) designed to support and secure an electrical line 166 to connect to the electrodes 130A, 130B. The electrical line 166 may comprise two separate wires, a twisted pair, or similar. As shown in FIG. 10A, the channel 164 may enter the cover 158 on one side and may split into two electrically isolated portions such that a first wire may be positioned in a first portion and a second wire may be positioned in the second portion. The cover's channel 164 may generally mirror the tray's track 160 such that the channel 164 and the track 160 may align and overlay one another when the housing 154 is assembled.

In some embodiments, the ends of the electrical line 166 (e.g., the ends of each wire in each channel portion) may be exposed (any insulation may be removed) and electrically connected to the exposed portions 162 of each respective electrode 130A, 130B using conductive epoxy, solder, Z-axis adhesive, or similar techniques.

The cover 158 may be connected and secured to the tray 156 using an adhesive sealant (preferably fluid-tight) such that no test fluids or other contaminants may enter the combined tray 156 and cover 158 when assembled. The result is shown in FIG. 10B. As shown, a portion of the tray 156 which houses the metallized electrodes 130A, 130B may extend out from the cover 158, such that the electrodes 130A, 130B may be available to interact with fluid(s) under test to provide pH measurements. In this way, the tray 156 in this area may provide base support to the electrodes 130A, 130B during use.

While the above embodiments have been described in relation to using the more rigid electrodes 130A, 130B, the more flexible electrodes 104A, 104B of the other embodiments described herein also may be used in these implementations.

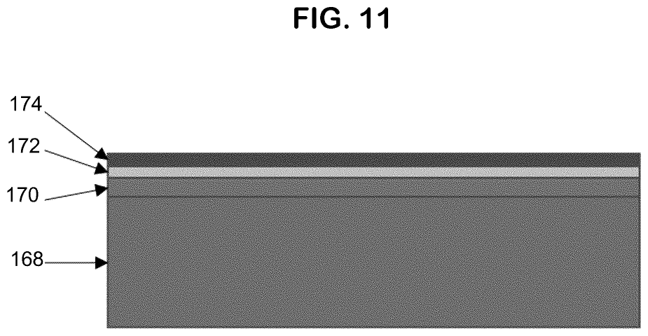

Various exemplary manufacturing techniques of the reference and working electrodes and of the overall flexible pH sensor 10 are described next with reference to FIGS. 11-15. For the purposes of the is description, the reference electrodes RE may include electrodes 104A, 130A, and/or other types of reference electrodes, and the working electrodes WE may include electrodes 104B, 130B, and/or other types of working electrodes.

In some embodiments, as shown in FIG. 11, the electrodes RE, WE may be manufactured using a metallized base substrate 168. The reference and working electrodes RE, WE may be fabricated on a common substrate 168. The base substrate 168 may include a polyimide sheet (preferably high temperature) coated with a first layer 170 comprising copper at a thickness suitable for electrical connectivity, and for providing a bonding layer to bond additional metallization layers to the polyimide film 168 (e.g., for the metallization of the reference and working electrodes RE, WE on the same common base substrate 168). Other materials, such as but not limited to, chromium, platinum, and/or silver also may be used (e.g., instead of copper).

The thickness of the base substrate 168 and of the copper layer 170 may be independent of the processing of additional layers used to form the electrodes RE, WE. For example, the characteristics of the base sheet 168 and/or of the copper layer 170 may be chosen based on the amount of flexibility required of the final electrodes RE, WE, the ability of the polyimide base sheet 168 to withstand the processing requirements to complete the electrode fabrication, and the ability to prevent any delamination, cracking, and/or other failure conditions that may impact the lifetime of the finished electrodes RE, WE.

A second layer 172 comprising gold may be coated onto the first layer 170 to receive the electrode metallization. The gold layer 172 may have a thickness of about 90 nm to 150 nm to minimize thermomechanical issues with the copper layer 170 and to maintain a continuous surface across the copper coating 170 without blemishes such as holes, delamination zones, etc.

In other embodiments, the gold layer 172 may be deposited directly onto the polyimide film 168 without the copper layer 170 therebetween. This may provide a more direct conductive pathway requiring less processing steps.

In some embodiments, a third layer 174 comprising the electrode metallization layer for either or both the reference and/or working electrodes RE, WE may be coated onto the top of the gold layer 172. For example, an area of the substrate 168 determined to include the working electrodes WE may be coated with a third layer 174 comprising IrO₂ (or other suitable material). Likewise, an area of the substrate 168 determined to include reference electrodes RE may be coated with a third layer 174 comprising Ag:AgCl. The IrO₂ layer 174 and/or the Ag:AgCl layer are preferably uniform and may be applied by dipping, screen printing, roller printing, ink jet printing, and/or by other suitable processes.

In a first example, in some embodiments, the IrO₂ layer 174 for the working electrodes WE may be fabricated via deposition of one or more coat(s) of IrOx (or IrCl to form IrOx through the thermal oxidation process as described below) to produce a layer thickness sufficient to coat the gold layer 172 and for the IrOx to reach a thickness where it will crystalize into an interlocked surface layer sufficient for proton transference capability when processed.

In some embodiments, the IrOx (or the IrCl to form the IrOx) may be applied using an iridium-based ink. The iridium-based ink may comprise an iridium chloride power, an alcohol and a mild acid. The alcohol is preferably high-proof, e.g., 200-proof or equivalent. Preferred embodiments include ethanol, methanol and other similar alcohols. Preferred mild acids include acetic acid, citric acid and other similar acids, that may be 70% or above in concentration.

The components of the iridium-based ink are preferably mixed until no solids are visible in the solution, e.g., so that it is not a suspension. Due to the alcohol, it is preferred that the ink is not heated, and is kept sealed, during the mixing process.

The relative amounts of iridium chloride powder, alcohol and mild acid used to form the iridium-based ink may approximately range at about 0.75-1.5 grams of iridium chloride, 35-50 ml of alcohol and 8-15 ml of mild acid. However, these relative amounts may vary depending on the application for which the pH sensor is to be used. The relative amounts may also depend on the desired viscosity of the ink, which may itself depend on the manufacturing process and equipment used to form the coating. The viscosity of the iridium-based ink may generally range around the viscosity of water. However, in some embodiments, the iridium-based ink may be less viscous than water thereby aiding in manufacturing processes involving ink jets printing. Alternatively, the viscosity of the iridium-based ink may be thicker than water, which may be preferable for manufacturing processes involving rollers, such as gravure or flexo printers.

Regardless of the manufacturing process and equipment used, it is preferred that uniform coatings are formed. To print uniform coatings with the iridium-based ink, the speed and pressure of the printing pads in the gravure or flexo printer may vary, since the density of the printing pads and rollers and their material vary by machine type and manufacturer. Likewise, jet ink printing with the iridium-based ink may also be sensitive to the printing dot size and density of the printing.

In sum, the thickness of the coatings formed on the electrode substrate are preferably highly uniform. This is because thicker areas of a coating may contain residual IrCl which may compromise the performance of the electrodes.

In some embodiments, the metal oxide IrOx may be formed by use of a chlorine compound of the metal, such as Iridium Chloride (IrCl), that when heated to a specific temperature range allows oxygen in the atmosphere to replace the chlorine thereby forming IrOx. This may be performed using a single cycle and/or by using a number of cycles, e.g., a number of cycles corresponding to the number of coating layers that were used in coating the gold layer 172. In addition, no inert gas or other process gas may be necessary in the heating system during the thermal process. The cycle time of the thermal transition process from a metal chloride to a metal oxide may vary depending on the metal involved and the thickness of the coating being oxidized.

For example, a thicker single layer of IrCl, e.g., 90 nm (nanometers) to 200 um (Microns), may be heated to about 50° C. to 150° C. for about 1 to 2 hours after which the temperature may be increased to about 275° C. to 350° C. for about 4 to 6 hours (all at a standard atmosphere) to form a thicker single layer of IrOx. In another example, if multiple thinner layers of IrCl are being applied, to form the IrOx layer, the thickness of the individual layers may be of any desired range, typically from 10's nm up to 200 microns. Each layer may be applied and then heated to an initial temperature of about 50° C. to 70° C. for 2 to 5 minutes after which the temperature may be increased to about 90° C. to 115° C. for about 10 to 20 minutes. After this, the full oxidation process cycle used in a single layer process preferably facilitates that full oxidation is achieved. In any event, it is preferable that the resulting layer of IrOx reaches a suitable thickness that is crystalized into an interlocked surface layer sufficient for proton transference capability.

The IrO₂ metallization may be replaced with other metal oxides that preferably provide similar electrical and chemical relationships with the sample materials being pH tested.

The reference electrode RE may be formed using a similar arrangement of the base substrate 168, the copper coating 170, and the gold coating 172, and with an upper layer 174 of silver/silver chloride (Ag/AgCl) (or other suitable material(s)) as directed for the reference electrode RE metallization.

The reference and working electrodes RE, WE may also be fabricated using a flexographic or gravure-type process (or similar) to print the electrode materials onto a carrier foil. An anilox roller (or similar) may transfer a volume of the electrode material in ink form onto the carrier at a uniform thickness.

In other embodiments, a stencil printing, jet ink, or nozzle printing may be used to transfer the electrode materials in ink form to the gold coated flexible polyimide substate 168. In some embodiments, multiple electrodes and/or electrode sets may be printed using multiple printing passes, e.g., using a roll-to-roll (R2R) and/or sheet fabrication processes such as lamination.

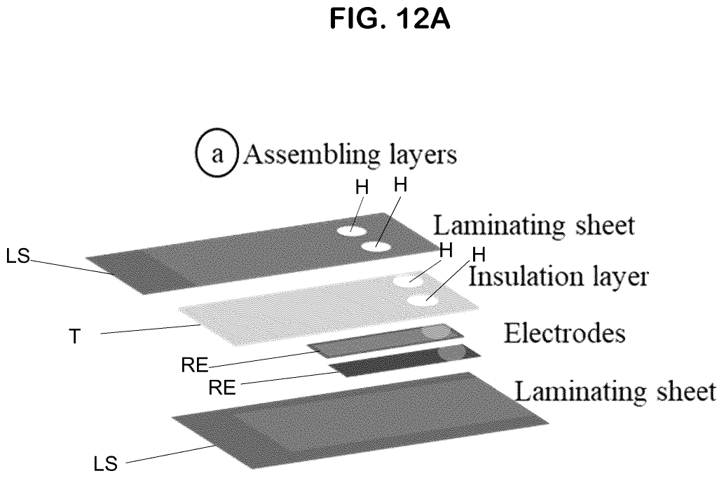

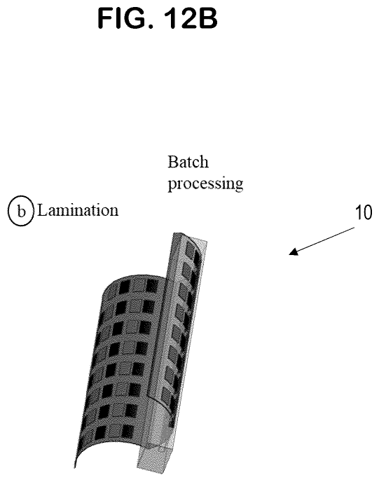

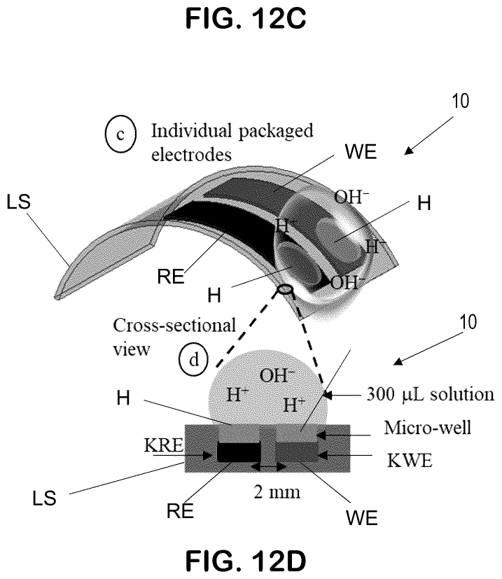

A generalized schematic of an exemplary manufacturing process for batched electrode assemblies is shown in FIGS. 12A and 12B. In some embodiments, the pH sensor 10 may be packaged by placing the electrodes RE, WE and a layer of insulating adhesive tape T between two laminating sheets LS (e.g., polyimide sheets as described herein). A mechanical punch (or similar) may be used to form holes H in one of the sheets LS (and the adhesive tape T as necessary) to expose a sensing area of each electrode RE, WE and to form microwells above each electrode RE, WE to contain the fluid under test. In some embodiments, the reference and working electrodes RE, WE may be fabricated separately and/or on a single substrate with adequate spacing to prevent electrical shorting.

In some embodiments, the batched electrode assemblies may then be passed through a thermal laminator resulting in the laminated assemblies of FIG. 12B. This process is suitable for large-scale films and may be integrated with the electrode manufacturing process. After batch processing, the assemblies may be cut or otherwise individualized into individual sensors 10 as shown in FIG. 12C. This process may be cost-effective without requiring a vacuum environment or a wafer transfer.

FIGS. 12C and 12D show an individual pH sensor 10 in use, with FIG. 12B showing a cross-sectional view of the electrodes RE, WE. As shown, a small volume (e.g., one microliter to a few hundred microliters) of test solution may be applied to the microwells to cover both the reference and working electrodes RE, WE and to provide electrical connectivity between the two (to complete the circuit) for accurate pH measurements. Preferably, the layer of insulating adhesive tape T positioned between the laminated sheets LS (see FIG. 11A) may provide an adequate seal to prevent any test solution from shorting the electrodes RE, WE or any connectivity lines connected thereto.

Next, the electrodes RE, WE may be defined by scribing, cutting the bulk sheet or roll form, and/or by using photolithographic-printing and/or etching techniques. Cutting processes may include die stamping, roll or knife cutting, and/or laser cutting.

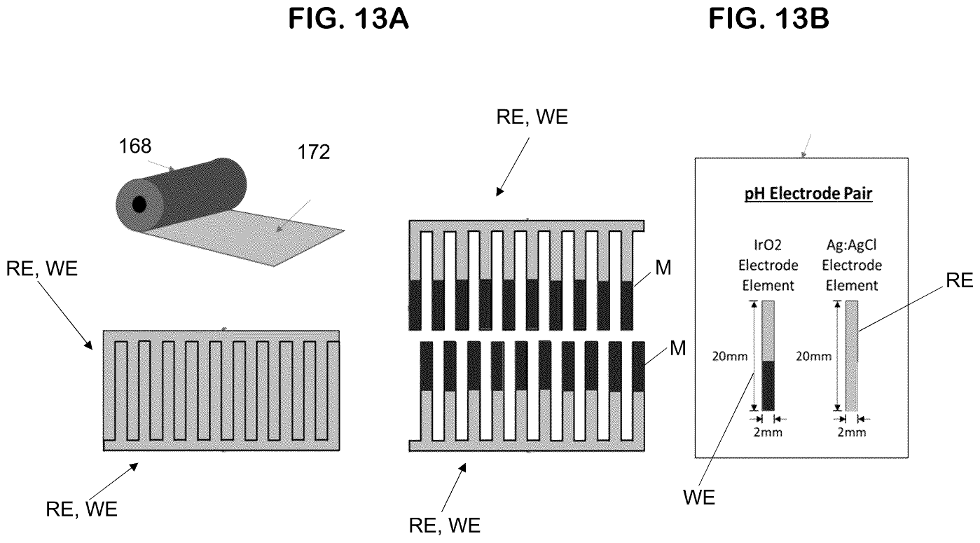

An example of this process is shown in FIGS. 13A and 13B. FIG. 13A shows a roll of the gold coated base sheet 168 with the gold coated layer 172 on the inside-facing surface. As shown in FIG. 13B, the rolled sheet 168 may be patterned for processing into individual electrodes RE, WE by die cutting, laser cutting. scroll cutting, photolithographic patterning, etching, and/or by other suitable techniques (preferably all computer-controlled). In the example shown, this may result in two face-to-face sections of defined electrodes RE, WE that may be separated to form two separate sections of bulk electrodes RE, WE. The sections of electrodes RE, WE may then be coated with an appropriate metallization M (e.g., Ag/AgCl for reference electrodes RE and/or IrO₂ for working electrodes WE) and then processed accordingly (e.g., at the proper temperature processing cycle(s) for each specific metallization). The resulting electrodes RE, WE may then be individualized and configured with one another for use as a pH sensor 10 as described herein or otherwise (see FIG. 12B).

In some embodiments, as shown in FIG. 12B, the resulting electrodes RE, WE may be about 20 mm in length and about 2 mm in width. However, it is appreciated that the electrodes RE, WE may be formed at other sizes depending on the particular applications.

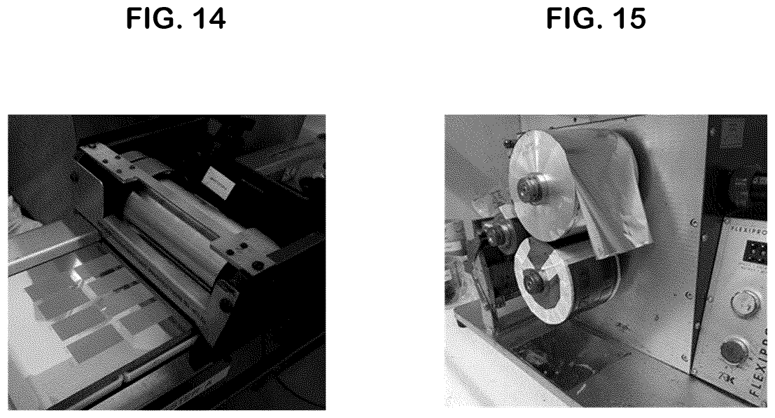

FIGS. 13 and 14 show images of commercially available processing equipment suitable for performing at least some of the processing techniques described herein, with FIG. 13 showing a laboratory-scale version of a RK Flexiproof 100 printer that utilizes the Flexo printing process, and FIG. 14 showing an example Gravure printing system.

It is understood that any aspects and/or details of any embodiments of the pH sensor 10 and its elements described herein may be combined with any aspects and/or details of any other embodiments of the pH sensor 10 and its elements described herein to form additional embodiments of the pH sensor 10 and its elements all of which are within the scope of the pH sensor 10 and its elements.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A pH sensor comprising:
a flexible base substrate including an upper base surface;
a first electrode coupled to the upper base surface and including a first electrode surface with a first metallization facing away from the upper base surface;
a second electrode coupled to the upper base surface and including a second electrode surface with a second metallization facing away from the upper base surface;
a first conductive line including a first line first end electrically connected to the first metallization and a first line second end adapted to be electrically connected to separate equipment; and
a second conductive line including a second line first end electrically connected to the second metallization and a second line second end adapted to be electrically connected to the separate equipment;
wherein the first and second metallizations are chosen to provide an indication of a pH level of a test material in electrical contact with the first and second metallizations by taking electrical measurements across the first and second conductive lines using the separate equipment.

2. The pH sensor of claim 1 wherein the first metallization includes silver/silver chloride (Ag:AgCl) and the second metallization includes iridium oxide (IrO₂).

3. The pH sensor of claim 1 wherein the first and second conductive lines are configured on a flexible connection substrate coupled to upper base surface and adjacent the first and second electrodes.

4. The pH sensor of claim 1 wherein the first conductive line is electrically connected to the first metallization using a first conductive tape and/or the second conductive line is electrically connected to the second metallization using a second conductive tape.

5. The pH sensor of claim 4 further comprising a first adhesive layer sealing at least a portion of the first conductive line, the first metallization and the first conductive tape, and/or a second adhesive layer sealing at least a portion of the second conductive line, the second metallization and the second conductive tape.

6. The pH sensor of claim 5 further comprising a protective sheet covering at least a portion of the first adhesive layer and/or the second adhesive layer.

7. The pH sensor of claim 1 further comprising:
a third electrode coupled to the upper base surface and including a third electrode surface with a third metallization facing away from the upper base surface; and
a third conductive line including a third line first end electrically connected to the third metallization and a third line second end adapted to be electrically connected to the separate equipment.

8. The pH sensor of claim 1 further comprising:
a third conductive line adjacent to the first conductive line or to the second conductive line and adapted to be electrically connected to the separate equipment; and
a thermal sensor electrically connected between the third conductive line and the first conductive line or between the third conductive line and the second conductive line.

9. A pH sensor comprising:
a flexible base sheet including an upper base surface;
a first conductive line configured on the upper base surface and including a first line first end and a first line second end, the first line second end adapted to be electrically connected to separate equipment;
a second conductive line configured on the upper base surface and including a second line first end and a second line second end, the second line second end adapted to be electrically connected to the separate equipment;
a first electrode including a first electrode surface with a first metallization electrically mounted onto the first conductive line at the first line first end, the first electrode surface facing away from the upper base surface; and
a second electrode including a second electrode surface with a second metallization electrically mounted onto the second conductive line at the second line first end, the first electrode surface facing away from the upper base surface;
wherein the first and second metallizations are chosen to provide an indication of a pH level of a test material in electrical contact with the first and second metallizations by taking electrical measurements across the first and second conductive lines using the separate equipment.

10. The pH sensor of claim 9 wherein the first electrode is electrically mounted onto the first conductive line and the second electrode is electrically mounted onto the second conductive line using conductive adhesive or wire bonding.

11. The pH sensor of claim 9 wherein the first electrode includes a first electrical via passing from the first metallization to the first conductive line and/or the second electrode includes a second electrical via passing from the second metallization to the second conductive line.

12. A method of manufacturing a pH sensor comprising:
providing a base substrate with a first surface coated with a first metallization;
coating the first metallization with a second metallization;
defining at least one first electrode on the third metallization;
separating at least one of the at least one defined first electrodes to form at least one separate first electrode;
coating at least a portion of the at least one separate first electrode with a third metallization;
wherein the third metallization is chosen to provide an indication of a pH level of a test material in electrical contact with the third metallization by taking electrical measurements between the third metallization and a corresponding electrode using separate equipment.

13. The method of claim 12 further comprising:
coating the first metallization with a fourth metallization;
defining at least one second electrode on the fourth metallization;
separating at least one of the at least one defined second electrodes to form at least one separate second electrode;
coating at least a portion of the at least one separate second electrode with a third metallization;
wherein the third metallization is chosen to provide an indication of a pH level of a test material in electrical contact with the fourth metallization and the third metallization by taking electrical measurements between the fourth and third metallizations using the separate equipment.

14. The method of claim 13 further comprising:
providing a first laminating sheet and a second laminating sheet;
providing an insulation layer;
placing the at least one separate first electrode, the at least one separate second electrode, and the insulation layer between the first and second laminating sheets to form a pH sensor assembly; and
laminating the pH sensor assembly to form at least one pH sensor.

15. The method of claim 14 wherein the first and second laminating sheets and the insulating layer include first apertures aligned to expose at least a portion of the first separate electrode and second apertures aligned to expose at least a portion of the second separate electrode.

16. The method of claim 12 wherein the second metallization includes gold.

17. A method of manufacturing a pH sensing electrode, comprising:
providing a first substrate including a first surface;
coating the first surface with a layer of iridium chloride to form a first coated substrate;
baking the first coated substrate over at least one temperature cycle;
wherein the baking causes at least a portion of the layer of iridium chloride to transition to a layer of iridium oxide.

18. The method of claim 17 wherein the layer of iridium oxide includes a thickness that is crystalized into an interlocked surface area sufficient for proton transference.

19. The method of claim 17 wherein the coating of the first surface with a layer of iridium chloride is performed using a single cycle, and the at least one temperature cycle includes heating the first coated substrate at about 50° C. to 150° C. for about 1 to 2 hours and then at about 275° C. to 350° C. for about 4 to 6 hours.

20. The method of claim 17 wherein the coating of the first surface with a layer of iridium chloride is performed using a two or more cycles, and the at least one temperature cycle for each cycle includes heating the first coated substrate at about 50° C. to 70° C. for 2 to 5 minutes and then at about 90° C. to 115° C. for about 10 to 20 minutes.
